(19) United States
(12) Patent Application Publication
(10) Pub. No.: US 2020/0286045 A1
(43) Pub. Date: Sep. 10, 2020

(54) Product Classification System Including a Supplier and Retailer Portals

(71) Applicant: Waste Repurposing International, Inc., Austin, TX (US)

(72) Inventor: Christopher B. Ripley, Lichtfield, CT (US)

(73) Assignee: Waste Repurposing International, Inc., Austin, TX (US)

(21) Appl. No.: 16/294,310

(22) Filed: Mar. 6, 2019

(51) Int. Cl. G06Q 10/00; G06Q 30/06; G06F 16/906; G06F 16/9038

(52) U.S. Cl. CPC G06Q 10/30; G06F 16/9038; G06F 16/906; G06Q 30/0627

(57) ABSTRACT

A system may include an interface communicatively coupled to a network, a processor, and a memory to store instructions that cause the processor to receive data about a retail product from one of a retailer system and a supplier system through the network. The instructions may further cause the processor to automatically parse and index attributes from the received data, determine one or more classifications based on the indexed attributes, and provide retail product data including the one or more classifications to the retailer system via the network.

### FIELD

The present disclosure is generally related to retail and supplier systems, and more particularly to systems, devices, and methods to classify products for safe handling and disposal that include portals for both retailers and suppliers to provide information, review their provided information, and view resultant calculations and classifications of products.

### BACKGROUND

Retailers have a legal responsibility to properly handle, and dispose of, products that are deemed as regulated by government bodies. When retailers receive products from suppliers, the received product may be entered into the retailer's inventory system. With respect to household hazardous waste products, such as cleaning products and the like, or other products that are regulated by government agencies, the chemical composition and regulatory handling requirements may be unknown to the retailer and may be difficult to determine with certainty.

### SUMMARY

Embodiments of systems, methods, and devices are described below that can include a classification system to automatically parse information received from retailers and from suppliers and to automatically deduce or calculate a plurality of attributes associated with each of a plurality of retail products. The attributes may include a Chemical Abstracts Service (CAS) number, physical attributes, composition data, other data, or any combination thereof. The classification system may automatically calculate toxicity, hazards, waste codes, and transportation classifications based on the attributes and may provide the calculated information to a retailer system to assist a retailer in safe handling and disposal of each retail product.

When the classification system fails to extract or calculate a particular attribute, data related to the retail product and the missing attribute may be “crowd sourced” by providing the data to one or more websites, to one or more independent contractors, or any combination thereof in order to determine the missing attributes. In particular, the classification system may be configured to provide data related to a retail product and to solicit information from one or more users to fill in missing information. In response to receiving information from the “crowd”, the classification system may selectively update the data record to include the missing information. The classification system may then use the attributes to automatically calculate toxicity, hazards, waste codes, and transportation classifications based on the attributes and may provide the calculated information to a retailer system to assist a retailer in safe handling and disposal of each retail product.

In some embodiments, a system may include a retailer system, a supplier system, and a third-party classification system, which may communicate with one another through a network, which may include the Internet. The retailer system may include a retail portal through which an operator may enter and view information about a retail product. The retail portal may be configured to communicate with the inventory system of the retailer. Upon entry of a new product into the retail portal, the retailer system may search an existing database for the chemical composition and regulatory handling requirements for the new product. If the new product is not found in the existing database, the retailer system may communicate with the third-party classification system to attempt to automatically retrieve, deduce, or calculate the chemical composition and regulatory handling requirements. If the third-party classification system has the information, the classification system may return the requested information to the retailer system. If the third party classification system does not have the information, the classification system or the retailer system may send a request to a supplier system to require the supplier to supply the chemical composition information, or other information about the product. The chemical composition provided by the supplier via the supplier portal may be shared with the third-party classification system and the retailer system. In some embodiments, the third party classification system may automatically determine regulatory handling rules for a particular product based on the chemical composition, which automatically determined rules may be reviewed and verified by an operator before they are shared with the retailer. Other embodiments are also possible.

In some aspects, the product classification system may be configured to manage a workflow. In an example, the workflow may be initiated by entry of a new product via a retail portal at the retail system. The retail portal may submit the product information to the product classification system, which may search its product database for a match. If a match is found, the product classification system may send the information from the product database to the retail system. The information may include chemical composition data, handling information, disposal information, other data, or any combination thereof.

When the database of the product classification system does not have a match to the product information, the product classification system may send a request for information to a supplier system of a supplier associated with the product. An authorized user of the supplier system may access a supplier portal to view the request and to provide chemical composition and other data related to the product information request. The product classification system may receive information from the supplier system and may automatically parse and index attributes from the received information and store the information in a data record associated with the retail product. In some instances, the product classification system may automatically deduce or calculate attributes from the received information, which attributes may also be stored in the data record. If the classifier system fails to extract a particular attribute, the product classification system may generate a graphical interface including the automatic classification information and product handling guidelines for review. When the automatic classification information is confirmed, the product classification system may send the classification information and the handling guidelines to the retailer system. Other embodiments are also possible.

In some embodiments, a system may include an interface communicatively coupled to a network, a processor, and a memory to store instructions that cause the processor to receive data about a retail product from one of a retailer system and a supplier system through the network. The instructions may further cause the processor to automatically parse and index attributes from the received data, determine one or more classifications based on the indexed attributes, and provide retail product data including the one or more classifications to the retailer system via the network. In some embodiments, determining the one or more classifications may include automatically deducing or calculating the classifications.

In other embodiments, a method may include receiving data about a retail product from one of a retailer system and a supplier system through the network and automatically parsing attributes from the received data. The parsed attributes may include a chemical abstracts services number and other data. The method may further include automatically indexing the parsed attributes, determining one or more classifications based on the indexed attributes, and providing retail product data including the one or more classifications to the retailer system via the network. In some embodiments, the one or more classifications may be automatically determined by automatically calculating the classifications based on the attributes, automatically deducing the classifications based on the attributes, or any combination thereof.

In still other embodiments, a system may include an interface communicatively coupled to a network, a processor, and a memory to store instructions. The instructions may cause the processor to receive data about a retail product from one of a retailer system and a supplier system through the network and automatically parse and index attributes from the received data. The instructions further may cause the processor to automatically determine a plurality of classifications based on the indexed attributes. The plurality of classifications may include one or more toxicity classifications, one or more hazards classifications, one or more waste code classifications, and one or more transportation classifications. The instructions can cause the processor to provide retail product data including the plurality of classifications to the retailer system via the network.

### BRIEF DESCRIPTION OF THE DRAWINGS

FIG. 1 depicts a block diagram of a product classification system, in accordance with certain embodiments of the present disclosure.

FIG. 2 depicts a block diagram of the product classification system of FIG. 1 including expanded diagrams of a retailer system and a supplier system, in accordance with certain embodiments of the present disclosure.

FIG. 3 depicts a flow diagram of a method of classifying a product, in accordance with certain embodiments of the present disclosure.

FIG. 4 depicts a flow diagram of a method of classifying a product, in accordance with certain embodiments of the present disclosure.

FIG. 5 depicts a flow diagram of a method of classifying a product using social media, in accordance with certain embodiments of the present disclosure.

FIG. 6 depicts a graphical interface provided by a retailer portal showing a request for product information, in accordance with certain embodiments of the present disclosure.

FIG. 7 depicts a graphical interface provided by a supplier system showing emails of requests for product information, in accordance with certain embodiments of the present disclosure.

FIG. 8 depicts a graphical interface provided by the supplier system showing fields for entering product information, in accordance with certain embodiments of the present disclosure.

FIG. 9 depicts a graphical interface provided by the supplier system and supporting multi-component kits, in accordance with certain embodiments of the present disclosure.

FIG. 10 depicts a graphical interface provided by the retailer system showing the status of prior requests for product information, in accordance with certain embodiments of the present disclosure.

FIG. 11 depicts a table of data extracted, transformed, and loaded from retailer data and supplier data received from the retailer system and the supplier system, in accordance with certain embodiments of the present disclosure.

FIG. 12 depicts a table of chemical abstract service (CAS) numbers and attributes stored by the product classification system and used to determine toxicity, hazards, waste codes, and transportation classifications, in accordance with certain embodiments of the present disclosure.

FIG. 13 depicts a graphical interface provided by the product classification system and including classification data for a particular product for review, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computer processor or controller. In accordance with various embodiments, the methods and functions described herein may be implemented as one or more software programs running on a computing device, such as a tablet computer, smartphone, personal computer, server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage medium or memory device, including instructions that when executed cause a processor to perform the methods.

Embodiments of systems, devices, and methods are described below that may be used to automatically calculate toxicity values, hazards, waste codes, and transportation classifications for a selected retail product, such as a chemical product, based on one or more attributes determined from at least one of a retailer system and a supplier system. The system may include a classification system to facilitate the exchange of information between a retailer and a supplier. As used herein, the term “chemical” refers to any substance or mixture of substances. The various types of chemicals can include a substance, an element, a chemical compound, or a mixture. A substance refers to chemical elements and their compounds in a natural state or obtained by any production process, including any additives to preserve the stability of the product and any impurities deriving from the process used, but excluding any solvent that can be separated without affecting the stability of the substance or without changing its composition. An Element refers to the simplest form of matter, such as the 118 elements of the periodic table (e.g., carbon, chlorine, hydrogen, oxygen, and so on). A Chemical Compound refers to a substance including two or more elements combined or bonded together so that its constituent elements are always present in the same proportions. A Mixture refers to a combination or a solution composed of two or more substances in which the substances do not react. Most retail products may be considered “chemicals” under this definition.

OSHA's Hazard Communication Standard (HCS) excludes hazardous waste as defined by the Solid Waste Disposal Act, as amended by the Resource Conservation and Recovery Act of 1976 (42 U.S.C. 6901, et sequence) and subject to regulations issued under the Act by the Environmental Protection Agency (EPA). The HCS also excludes any hazardous substance as defined by the Comprehensive Environmental Response, Compensation and Liability Act (42 U.S.C. 9601 et sequence) when the hazardous substance is the focus of remedial or removal action being conducted under that Act in accordance with EPA regulations. Further, the HCS excludes tobacco or tobacco products, wood or wood products, articles defined as a manufactured item other than a fluid or particle, food or alcoholic beverages, drugs as defined in the Federal Food, Drug, and Cosmetic Act (21 U.S.C. 301 et sequence), and cosmetics. Further, the HCS excludes consumer products or hazardous substances defined in the Consumer Product Safety Act (15 U.S.C. 2051 et sequence) and the Federal Hazardous Substances Act (15 U.S.C. 1261 et sequence) where an employer can show that the product is used in the workplace for the purpose intended by the manufacturer or importer of the product. Further, HCS excludes nuisance particulates where the chemical manufacturer or importer can establish that they do not pose any physical or health hazard; ionizing and non-ionizing radiation; and biological hazards. HCS specifies that a physical hazard refers to a chemical that is classified as posing one of the following hazardous effects: explosive; flammable (gases, aerosols, liquids, or solids); oxidizer (liquid, solid, or gas); self-reactive; pyrophoric (liquid or solid); self-heating; organic peroxide; corrosive to metal; gas under pressure; or in contact with water emits flammable gas. The HCS defines a health hazard as a chemical that is classified as posing one of the following hazardous effects including acute toxicity; skin corrosion or irritation; serious eye damage or eye irritation; respiratory or skin sensitization; germ cell mutagenicity; carcinogenicity; reproductive toxicity; specific target organ toxicity; or aspiration hazard.

In some embodiments, the toxicity values may include a toxicity reference value (TRV), which is a toxicological index that, when compared with exposure, is used to qualify or quantify a risk to human health. TRVs may be developed in a variety of ways based on available data on the substances' toxicological mechanisms of action and on commonly accepted assumptions: TRVs can be developed according to a highly structured and rigorous approach involving collective assessments.

In some implementation, once the chemical composition of a retail product is determined, a classification system may determine relevant data concerning the hazards of each chemical and chemical combination, and determining if the chemical is hazardous based on its physical, health, and environmental hazards. The hazard classification process may include automatically searching scientific literature and evidence to determine whether the chemical or chemical composition is classified as hazardous based on a definition of hazardous defined by the Occupational Safety and Health Administration (OSHA). The hazard classification process may further include determining the degree of the hazard by comparing the data with criteria for health and physical standards. Other embodiments are also possible.

In certain embodiments, the systems, methods, and devices may provide graphical interfaces through which users may request, provide, and receive information about a product. In an example, a retailer may view and enter product information and request chemical content information associated with a particular retail product received from a supplier. The system may include a classification system configured to facilitate communication between the retailer and a supplier. The request from the retailer may be provided to the supplier as an email or other communication. The supplier may view and interact with the email or other communication to supply the requested information. The workflow from the retailers request through submission of the requested information may be tracked automatically to ensure that the request is fulfilled. In some instances, the workflow may cause the classification system to automatically send reminders if a pre-determined time elapses without a response.

Further, upon submission of the requested information, a classification system may automatically parse selected attributes from the information and may use the attributes to automatically calculate toxicity, hazards, waste codes, and transportation classifications based on the attributes and may provide the calculated information to a retailer system to assist a retailer in safe handling and disposal of each retail product. The results of the calculation as well as the information from the supplier may be provided to the retailer.

It should be appreciated that the classification system may be configured to receive information from both a retailer and a supplier, and that, in some instances, such information may be confidential (such as the composition information for a particular product). The classification system may be configured to maintain such information securely and may include provisions and security to ensure that such information remains confidential. Further, the classification system may provide toxicology, hazards, waste codes, transportation, and optionally sorting classifications to the retailer system based on the composition information and without disclosing the composition information. Other implementations are also possible.

In some embodiments, a product classification system may provide a graphical interface to a retailer system that can be accessed by an operator of the retailer system to view and enter product data. The product classification system may receive data related to a retail product from the retailer system. The product classification system may search a existing database in response to the received data and, when there is no match, the product classification system may send a request for information to a supplier system. An authorized user at the supplier system may access a supplier portal interface to view the request and to provide the information about the product in response to the request. In response to receiving the information, the product classification system may update the product record and may automatically determine (lookup, calculate, deduce, or otherwise identify) chemical, toxicological, and regulatory data from other sources based on the data provided by the supplier. The product classification system may then update the computing device of the retailer with at least some of the determined information.

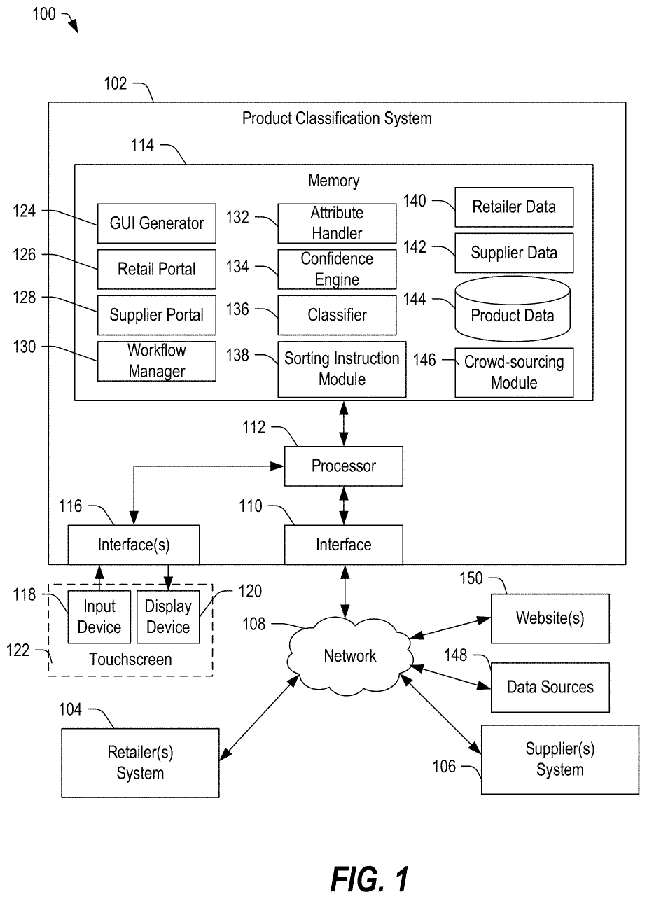

In some embodiments, the classification system may automatically parse received data to extract a plurality of attributes and automatically index the extracted attributes into a predetermined data structure, which can be readily searched and accessed. In an example, the classification system may parse data from a Safety Data Sheet (SDS) to extract the potential hazards (health, fire, reactivity and environmental) and data indicating how to work safely with the chemical product. In some embodiments, the parsed attributes may include a Chemical Abstracts Service (CAS) number, composition data including composition percentages, flashpoint data, acidity (pH) value; density data, other data, or any combination thereof related to a retail product. In some instances, the attributes may include product label images, packaging images, other image data, or any combination thereof. The classification system may use the parsed attributes, such as the CAS number, to automatically retrieve, calculate, or deduce chemical, toxicological, and regulatory data from one or more data sources. The parsed attributes and the retrieved data may be used by the classification system to automatically calculate toxicity data, hazard levels, waste codes, and transportation classifications for a retail product. The classification system may also perform lookups based on other attributes, such as a United Nations (UN) number assigned by the United Nations Committee of Experts on the Transport of Dangerous Goods, a Packing Group Number (in which dangerous goods are assigned into 3 packing groups (also known as UN Packing Group) in accordance with the degree of danger they present: Packing Group I: high danger. Packing Group II: medium danger. Packing Group III: low danger), or another attribute that can be used to determine regulatory and handling information for the retail product. One possible example of a system to classify products is described below with respect to FIG. 1.

FIG. 1 depicts a block diagram of a system 100 including a product classification system 102, in accordance with certain embodiments of the present disclosure. The product classification system 102 may be coupled to or configured to provide a graphical interface to a retailer system 104 through a network 108. The product classification system 102 may also be coupled to or configured to provide a graphical interface to a supplier system 106 through the network 108. Additionally, the product classification system 102 may be coupled to one or more data sources 148 (such as systems that provide information, such as databases, document repositories, other data sources, or any combination thereof) and to one or more websites 150 through the network 108.

The product classification system 102 may include an interface 110 configured to communicate with one or more computing devices (including the retailer system 104 and the supplier system 106) through the network 108. The network 108 may include a local area network (LAN), a Bluetooth® network, a satellite network, a cellular network, the Internet, other networks, or any combination thereof. The product classification system 102 may further include a processor 112 coupled to the interface 110. The product classification system 102 may also include a memory 114 coupled to the processor 112 and one or more interfaces 116 coupled to the processor 112. The interfaces 116 may be coupled to an input device 118 (such as a keypad, a pointer, a barcode reader, another input device, or any combination thereof) to receive input data from an operator. The interfaces 116 may also be coupled to a display device 120 to provide a graphical interface including text, images, user-selectable elements (clickable links, buttons, fields, checkboxes, radio buttons, pulldown menus, other selectable elements, or any combination thereof), and other features. In some embodiments, the input device 118 and the display device 120 may be combined in a touchscreen 122. Other embodiments are also possible.

The memory 114 may include a graphical user interface (GUI) generator 124 that, when executed, may cause the processor 112 to generate a graphical interface for display on the display device 120 or touchscreen 122. In some embodiments, the graphical interface may include product data, chemical content data, and auto-classification data (including product handling guidelines) for review by the operator. The operator may interact with the graphical interface via the input device 118 or the touchscreen to review, edit, and either approve or reject the classification and handling data for a particular product.

The memory 114 can include a retail portal module 126 that, when executed, may cause the processor 112 to generate a retail portal graphical interface including data and including user-selectable elements (such as clickable links, buttons, fields, checkboxes, radio buttons, pulldown menus, other selectable elements, or any combination thereof) and to provide the retail portal graphical interface to the retail system 104. The memory 114 may further include a supplier portal module 128 that, when executed, may cause the processor 112 to generate a supplier portal graphical interface including data and including user-selectable elements (such as clickable links, buttons, fields, checkboxes, radio buttons, pulldown menus, other selectable elements, or any combination thereof) and to provide the supplier portal graphical interface to the supplier system 106.

The memory 114 may include a workflow manager 130 that, when executed, may cause the processor 112 to track the progress of a product information request, including whether the information was found within the existing database and whether the supplier has responded to the information request. The workflow manager 130 may provide a task interface within the retail portal graphical interface and within the supplier portal graphical interface so that the operator at the retailer and the operator at the supplier can track progress of the product information request. In some embodiments, the workflow manager 130 may provide tasks in the form of emails sent to the supplier system 106, the retailer system 104, or both. Further, the workflow manager 130 may trigger reminder emails when a pre-determined time period has elapsed.

The memory 114 can include an attribute handler 132 that, when executed, may cause the processor 112 to extract, transform, and load attributes from data received from the retailer system 104 or the supplier system 106 into a pre-determined data structure. The attribute handler 132 may also correlate product data from the retailer system 104 to the data (SDS information, CAS number, composition data, other data, or any combination thereof) received from the supplier system 106. In a particular example, the attribute handler 132 may automatically parse selected attributes from an SDS document received from the supplier system 106 and may index the selected attributes into a data record corresponding to the retail product within a product database 144. The parsed attributes may include a Chemical Abstracts Service (CAS) number, physical attributes, composition data including composition percentages, flashpoint data, acidity (pH) value; density data, other data, or any combination thereof. Additionally, the attribute handler 132 may cause the processor to capture, parse, and index image data and associate the image data with related product data within the product database 144. The attribute handler 132 may cause the processor 112 to utilize the CAS number and other attribute data to retrieve toxicological and regulatory data from one or more other data sources through the network 108. Such data sources may include Toxnet® (a trademark of the National Library of Medicine, THE FEDERAL AGENCY UNITED STATES, 8600 ROCKVILLE PIKE, BETHESDA, Md. 20894), other public data sources, Sigma-Aldrich® (a trademark of MERCK KGAA Kommanditgesellschaft auf Aktien (kgaa), Federal Republic of Germany, Frankfurter Str. 250 64293 Darmstadt FED REP GERMANY), other private data sources, or any combination thereof.

The memory 114 may further include a confidence engine 134 that, when executed, may cause the processor 112 to determine a confidence or reliability value for each data source and may process the extracted attributes to determine a canonical value or reliability weighting value for each attribute. For example, the attributes determined from data received from supplier systems 106 (or manufacturers) may include inconsistent or contradictory data. An SDS may list a product as “Not Regulated” in section 14, but in another section of the SDS lists the Flashpoint as 80 F and thus should be listed as flammable. The confidence or reliability value may be determined, at least in part, based on such an inconsistency. The canonical value or reliability weight value may be used to adjust the order in which the attributes are applied, for example, in determining toxicity and other classifications.

The memory 114 can further include a classifier 136 that, when executed, may cause the processor 112 to utilize the weighted attribute data to automatically determine transportation and waste classifications as well as sorting instructions for sorting device that may be used at a retailer location to sort unsaleable retail products (such as retail products that have damaged packaging, and the like). The classifier 136 may utilize the weighted attributes as well as the retrieved data from the one or more data sources to calculate toxicity, hazards, waste codes, and transportation classification, which can be correlated to the product data in the product database 144. The classifications may include ground transportation, air transportation, sea transportation, federal waste codes, state waste codes, sorter bin information (bins into which unsaleable items may be sorted at a retailer or other facility for further handling), other information, or any combination thereof. The classification data may be provided to a retailer portal graphical interface of the retailer system 104, and an operator may access one or more user-selectable options within the retailer portal graphical interface to flag records in order to trigger a manual “expert” review of a particular classification, which may cause the product classifier system 102 to provide the product information within a graphical interface that can be accessed by an “expert” operator to review the product information. In some embodiments, the graphical interface may include user-selectable options accessible by the “expert” operator to edit the product information, the classifications, or any combination thereof. It should be understood that an “expert” operator may be an operator authorized by the product classification system 102 to make changes to such information, and authorization may be provided to an individual determined to have knowledge about such issues.

In some embodiments, the memory 114 may include a sorting instructions module 138 that, when executed, may cause the processor 112 to determine classification data and sorting instructions for a sorting device at the retailer or other facility. The sorting device may including a computing device including an optical capture element (such as a camera, a barcode reader, or any combination thereof), a scale, a display, and a processor to provide a graphical interface to the display to guide an operator through a process of scanning and sorting unsaleable items into storage bins for subsequent handling and disposal. In this example, the sorting device may be used to scan a barcode of an item. The sorting device may then display information about the scanned item and may provide user-selectable options accessible by the operator to provide further information about the product (such as “damaged packaging”, etc.). The sorting device may then provide instructions for further handling based on the information provided and may specify which bin of a plurality of bins into which the product should be placed. In some instances, the sorting device may provide special instructions for handling of the package prior to bin placement, such as sealing the product into a plastic bag to prevent leakage. The sorting instructions module 138 may cause the processor 112 to push selected classifications to the sorting device including bin selection rules, product donation eligibility, recycle path, re-use in warehouse eligibility, other disposal paths (compactor, composter, drain, welding supply, and so on), multi-component handling instructions, other instructions, or any combination thereof.

The memory 114 may also include retailer data 140 including contact information, retailer-supplier correlations, facility handling rules, other data, or any combination thereof. The memory may further include supplier data 142 including contact information, supplier-retailer correlations, product information, other data, or any combination thereof. The memory 114 may further include a product database 144 including a plurality of data records, each of which may correspond to a particular retail product. Each data record may include product information, physical attributes, supplier information, safety information, classification data, sorting data, other data, or any combination thereof. Further, data records may be partially complete and may be updated as new information is received and correlated to the data records. Other embodiments are also possible.

In operation, the classifier system 102 may perform a variety of functions, including providing a graphical interface to the retailer system 104 including user selectable options accessible by the operator to enter data related to a retail product, such as a household hazardous waste product. When the retail product is already in the database at the retailer system 104, then the retailer system 104 can verify lookup the retail product, and the retailer system 104 may notify the operator via the graphical interface that the retail product documentation is complete and that the product may be placed on shelves for sale to a consumer.

When the chemical composition of the retail product is not known at the retailer, the retailer system 104 may send data related to the product to the product classification system 102. The product classification system 102 may search an existing database of product data 144 to identify a match. If no match is found, the product classification system 102 may issue an alert, for example, in the form of a message to a supplier portal graphical interface to the supplier system 106 to request chemical composition information. The message may take the form of an email message with user-selectable links to access a supplier portal graphical interface to provide requested information about the retail product. The classification system 102 may track progress of the messages and of the responses. By selecting the message, an operator of the supplier system 106 may access a supplier portal interface to view the request and to provide the requested information (such as composition information) by completing a form provided within the supplier portal, attaching documents, and so on, and then may submit the completed form. The submission from the supplier portal 106 may take the form of an email response.

The response may be received by the product classification system 102, which may automatically extract attributes from the received response; retrieve data based on one or more of the extracted attributes; automatically calculate or deduce toxicity, hazards, waste codes, and transportation codes based on one or more of the extracted attributes; and a determine a plurality of classifications corresponding to a retail product. The product classification system 102 may update the product data 144 with the determined product information. Further, the product classification system 102 may provide data related to the retail product and the determined classifications to the retailer system 104. In some embodiments, the data provided to the retailer system 104 may include classifications for ground transportation, air transportation, sea transportation, Federal waste codes, State waste codes, sorting bin information, other information, or any combination thereof.

By facilitating communications between the retailer system 104 and the supplier system 106, the classification system 102 may display information and assist the retailer in acquiring data about retail products. Moreover, the classification system 102 may parse, extract, and store attributes from data received or retrieved from any of the sources and may calculate or deduce classifications for safe handling and disposal of retail products that may be or may become unsaleable for a variety of reasons. In some embodiments, based on information received from the retailer system 104, the supplier system 106, and from other sources, the classification system 102 may assemble a record about each retail product that can include a plurality of product attributes. For each retail product, the product attributes can include a universal product code (UPC), a product name, a brand name, a manufacturer name, a safety data sheet (SDS), chemical composition data, component data, kit item data, a manufacturer part number, intended use information, form data, phase data, inner and outer packaging information, dimensions (weight, volume, material, and type), case quantity, battery data, special permits, registration numbers, overpack/display ready/unit load data, pictures of labels, and so on. The retailer may add additional “proprietary attributes” including an item number, a supplier number, a supplier name, a department number, a department name, a category number, other information, or any combination thereof.

In some implementations, one or more attributes may be unknown from data received from the supplier 106. For example, contradictory information with the SDS or unclear or missing information may be identified. In some embodiments, the memory 114 of the classification system 102 may include a crowd-sourcing module 146 that, when executed, may cause the processor 112 to provide information to one or more web sites 150 including some product information and a request for information corresponding to one or more attributes for which additional information is needed. Independent operators may provide such information, and the received information may be verified and then used to supplement the product information. Other implementations are also possible.

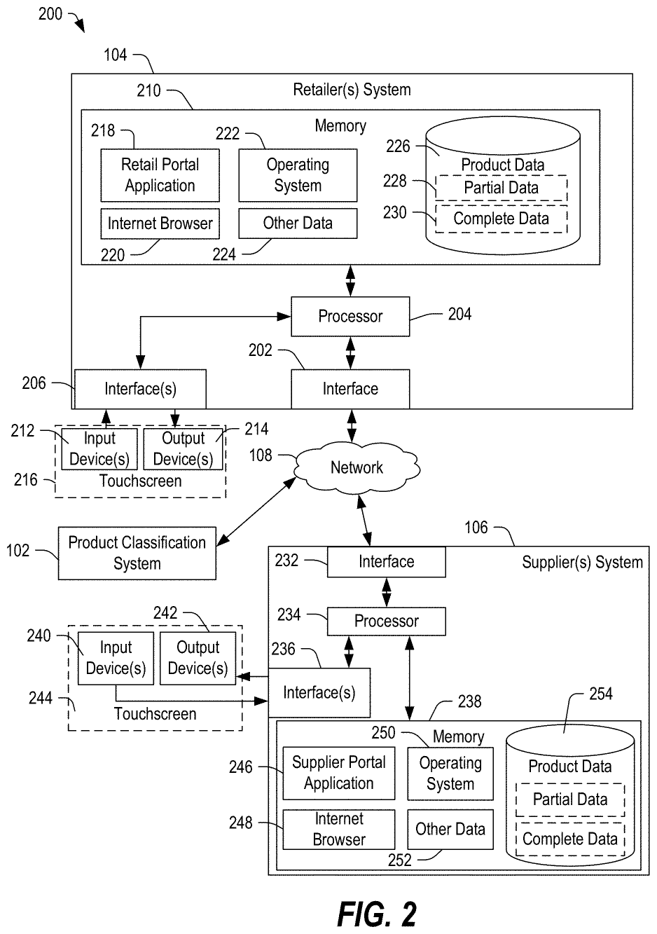

FIG. 2 depicts a block diagram of the product classification system 100 of FIG. 1 including expanded diagrams of a retailer system 104 and a supplier system 106, in accordance with certain embodiments of the present disclosure. The retailer system 104 may include an interface 202 communicatively coupled to the network 108. The retailer system 104 may further include a processor 104 coupled to the interface 202. Further, the retailer system 104 may include one or more interfaces 206 coupled to the processor 204. The retailer system 104 may also include a memory 210 coupled to the processor 204. The retailer system 104 may present a retailer portal graphical interface to an operator of the supplier system 104 to view data (including retail product data, request status data, and so on) and to enter information (including product data and requests for information from suppliers).

The retailer system 104 may be coupled to input devices 212 and optionally output devices 214. The input devices 212 may include keyboards, pointer devices, scanners, barcode readers, touch-sensitive interfaces, other input devices, or any combination thereof. The input devices 212 may be coupled to the interface 206. The output devices 214 may include display devices, printers, audio devices, other devices, or any combination thereof. In some embodiments, the input device 212 and the output device 214 may be combined as a touchscreen 216.

The memory 210 may include a retail portal application 218 that, when executed, may cause the processor 204 to present a retailer portal graphical interface that can be provided to the output device 214 (e.g., the display). The retail portal graphical interface may include a plurality of user-accessible options including pull-down menus, checkboxes, radio buttons, text fields, other elements, or any combination thereof. The operator may interact with one or more input devices 212 to enter information about a particular product. In some embodiments, instead of accessing a retail portal application 218, the operator may access the retail portal graphical interface using an Internet browser application 220. The memory 210 may also include an operating system 222, as well as data 224.

In this example, the memory 210 may include a database of product data 226, including partial product data 228. In this example, partial product data 228 may include information entered by the operator of the retail portal graphical interface. However the retailer may have insufficient information to complete the product data. For example, missing information may include, but is not limited to, chemical composition data and classification information, such as handling information related to safe handling and disposal of the retail product. The database of product data 226 may also include complete product data 230. The complete product data 230 may include information entered by the operator of the retail portal graphical interface, as well as chemical composition data, transportation and waste classification (whether the information is retrieved from the product classification system 102, the supplier system 106, entered by the operator, or any combination thereof). In some embodiments, the complete product data 230 may include sorting instructions that can be accessed by or pushed to a sorting device that can be used to barcode scan and sort unsaleable items.

The supplier system 106 may include an interface 232 communicatively coupled to the network 108. The supplier system 106 may further include a processor 234 coupled to the interface 232. Further, the supplier system 106 may include one or more interfaces 236 coupled to the processor 234. The supplier system 106 may also include a memory 238 coupled to the processor 234.

The supplier system 106 may be coupled to input devices 240 and optionally one or more output devices 242. The input devices 240 may include keyboards, pointer devices, scanners, barcode readers, touch-sensitive interfaces, other input devices, or any combination thereof. The input devices 240 may be coupled to the interface 236. The output devices 242 may include display devices, printers, audio devices, other devices, or any combination thereof. In some embodiments, the input device 240 and the output device 242 may be combined in the form of a touchscreen 244. Other implementations are also possible.

The memory 238 may include a supplier portal application 246 that, when executed, may cause the processor 234 to present a supply portal graphical interface that can be provided to the output device 242. The supply portal graphical interface may include a plurality of user-accessible options including pull-down menus, checkboxes, radio buttons, text fields, other elements, or any combination thereof. The operator may interact with one or more input devices 240 to enter information about a particular product, such as composition information, handling information, regulatory information, chemical substance identifiers (such as Chemical Abstracts Service (CAS) codes), other information, or any combination thereof. In some embodiments, instead of accessing a retail portal application 218, the operator may access the retail portal graphical interface using an Internet browser application 220. The memory 210 may also include an operating system 222, as well as data 224.

It should be appreciated that each of the product classification system 102, the retailer system 104, and the supplier system 106 may include one or more computing devices configured to communicate with one another to provide a system. Each of the systems 102, 104, and 106 may include multiple databases and multiple processors. An operator at any of the systems 102, 104, and 106 may access one of the computing devices to supply and review information. Other embodiments are also possible.

In some embodiments, email exchanges between the retailer system 104 and the supplier system 106 may be managed by the classification system 102, and the retailer portal graphical interface and the supplier portal graphical interface may be configured to display messages, retail product information, and other data and to receive data including information requests, data related to the messages, retail product information, other information, or any combination thereof. In some embodiments, the messages may appear as emails or tasks, and the operator may access and respond by selecting one of the messages and then filling in the appropriate information. Other implementations are also possible.

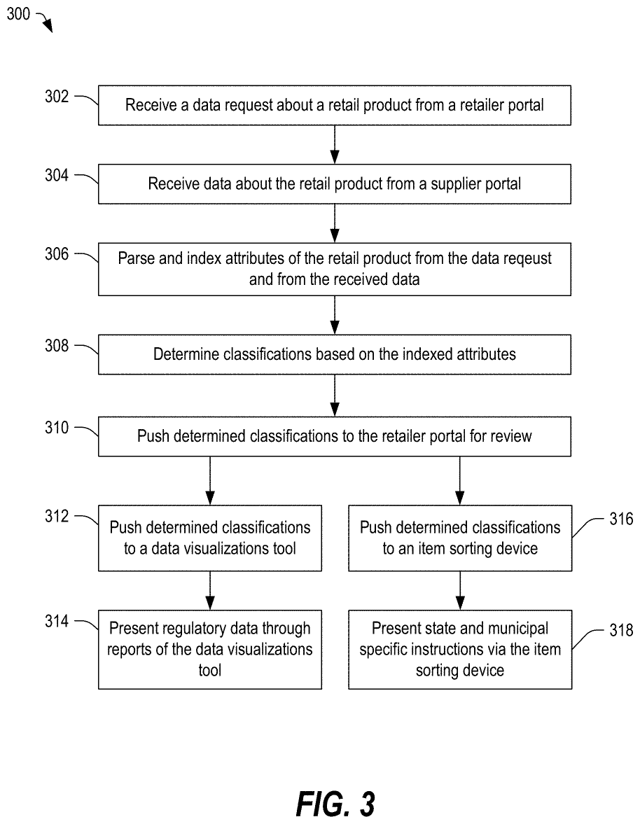

FIG. 3 depicts a flow diagram of a method 300 of classifying a product, in accordance with certain embodiments of the present disclosure. At 302, a data request may be received about a retail product from a retailer portal. An operator associated with the retailer may create the data request via the retailer portal. For example, an operator may use a barcode reader to scan a barcode of a label of a retail product and may enter information from the shipping manifest as well as other information, such as quantity, and so on. Some information about the retail product, such as composition data, may be unavailable to the operator. Accordingly, the data request may be initiated automatically by the system in response to detecting missing information. Alternatively, the operator may initiate a request manually, requesting that the supplier provide the missing information.

At 304, the method 300 can include receiving data about the retail product from a supplier portal. For example, the classification system 102 may receive the data request from the retailer portal and may provide the data request to the supplier system 106 within a supplier portal graphical interface to retrieve the data from the supplier. The classification system 102 may host the communication and may present the request as an email within the supplier portal graphical interface, which may display the email and provide user-selectable elements accessible by the operator to access the email, to enter the information, and to submit the information. The submitted information may be received by the classification system 102. Other implementations are also possible.

At 306, attributes associated with the retail product may be parsed and indexed from the data request and from the received data. For example, the classification system 102 may extract information from the data request received from the retailer portal and from the data supplied from the supplier portal and may index the extracted information into fields within the database so that the attributes are searchable. The attributes may include a UPC, a product name, a manufacturer name, contact information, a CAS number, chemical composition data, other data, or any combination thereof.

At 308, classifications may be determined based on the indexed attributes. For example, in one possible implementation, the classification system 102 can utilize the CAS number to look up toxicological and other information and may lookup transportation and handling rules for the particular retail product. In another example, the classification system 102 may utilize the CAS number to look up information about the retail product and may calculate or deduce the transportation, handling, and toxicological information based on the information. Other implementations are also possible.

At 310, the classifications may be pushed (provided) to the retailer portal for review. For example, the classifications may be provided by the classification system 102 in the form of an email that can be accessed and reviewed by an operator of the retailer system 104 via the retailer portal graphical interface. In an alternative implementation, prior to pushing the classifications to the retailer system 104, the classification system 102 may provide a graphical interface to a classifications “expert” (an individual with expertise and experience in determining toxicological, transportation, and waste handling rules and may provide the classification information within the graphical interface to allow the “expert” to review and optionally edit the classification information.

At 312 the determined classifications may be provided to a data visualizations tool. In one possible example, the determine classifications can be provided to Tableau® computer software by Tableau Software, Inc. of Seattle, Wash. For example, the data received by the retailer portal 104 may be rendered into one or more visualizations using the visualizations tool. Such visualizations may include various charts, graphs, and other information. Further, such visualizations may be selectable by the operator to view the data in various different ways.

At 314, regulatory data may be presented through reports of the data visualizations tool. For example, the visualizations tool may provide standard toxicological warning symbols and other information to assist the operator in understanding the classification information. Other implementations are also possible.

At 316, the determined classifications may be pushed (provided) to an item sorting device. The item sorting device may be a standalone device situated at a retail location. The item sorting device may include one or more optical sensors and a processor configured to identify an unsaleable retail product based on optical data from the optical sensors. The processor may be configured to apply the classifications to selectively sort the retail product into a bin or palette for subsequent disposal, repurposing, or donation. The classifications may be provided to the item sorting device, which may subsequently utilize the classifications to sort data into the appropriate bin or palette.

At 318, state and municipal specific instructions may be presented to a display of the item sorting device. For example, an unsaleable item may be scanned by the item sorting device, which may identify the retail produce and determine one or more classifications for the retail product, including the state and municipal instructions. Further, the item sorting device may present the classification information and the state and municipal instructions to the display of the item sorting device to assist an operator.

It should be appreciated that the systems, methods, and devices described above provide multiple benefits and advantages over conventional systems. One possible advantage may include automatically determined transportation and waste classifications that can reduce human error in the classification process. The automated classification may also prevent over-classification.

Further, the system may provide item sorting device instructions for processing optically scanned, unsaleable items, reducing the potential for human error and improving handling of unsaleable retail products. Further, the automated data acquisition may improve the quality of collected data and may save time, by capturing information for a retail product on behalf of retailers and using information collected from the suppliers. For retailers, the system may provide automated communication with suppliers for data acquisition purposes, saving time and enhancing data collection. For suppliers, the system facilitates the data upload process, making the data upload easier and faster than other available tools. Moreover, suppliers do not have to disclose trade secrets, in part, because information provided to the classification system 102 may be maintained at the classification system 102, and only the classification information may be provided to the retailer system 104, protecting supplier information from disclosure. Moreover, access to the supplier portal graphical interface may be provided at no cost to the supplier. Other advantages are also possible.

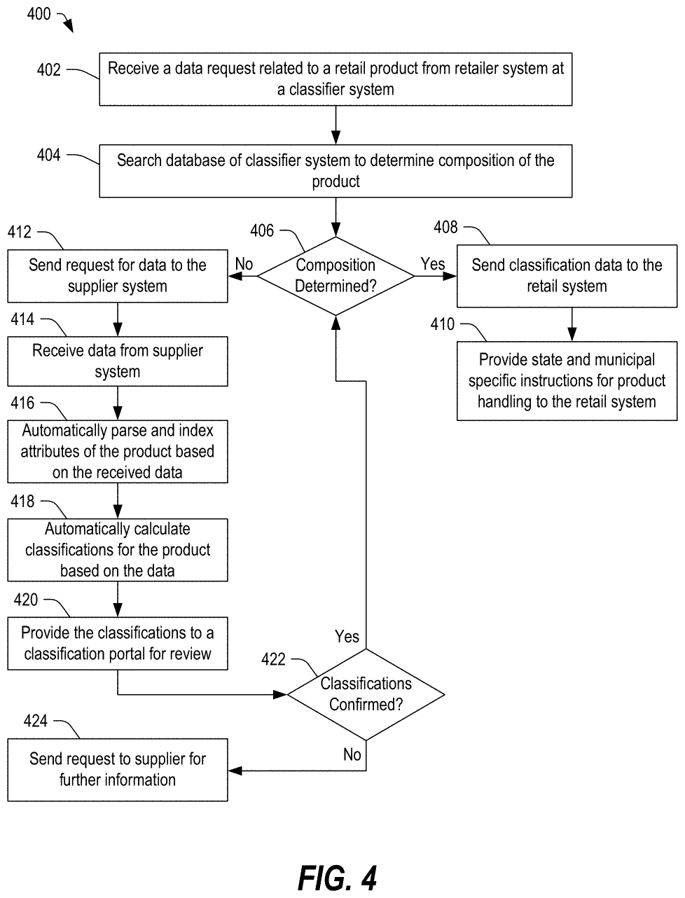

FIG. 4 depicts a flow diagram of a method 400 of classifying a product, in accordance with certain embodiments of the present disclosure. At 402, a data request related to a retail product may be received from a retailer system at a classifier system. For example, a data request may be automatically or manually initiated based on data entered by a retailer into the retailer portal graphical interface and submitted to the classification system 102. The data request may be received by the product classifier system 102. In some implementations, an operator may enter data related to a retail product at a retailer system using, for example, a retailer portal graphical interface, and the retailer system 104 may automatically search an existing retail database 226 to determine whether the product data is already available. When the existing retail database 226 does not have a match for the product data, the retailer system 104 may automatically generate the data request, which may be sent to the product classifier system 102. In some embodiments, the operator at the retailer system 102 may add as many UPCs or other product identifiers as he or she wants to enter that are associated with a particular supplier using the retailer portal graphical interface, and the multiple UPCs or product identifiers may be included in the data request. In an embodiment, the retailer portal graphical interface allows the operator to select a buyer contact and a vendor contact to facilitate communication between the parties.

At 404, a database of the classifier system may be searched to determine composition of the product. For example, the classification system 102 may parse the data request and may search the database 142 to identify the classifications and optionally the composition of the retail product or products.

At 406, if the composition is determined from the database 142 of the classifier system 102, the classification data may be sent to the retailer system, at 408. For example, the classification system 102 may determine the classifications from the database 142 and may send the classification data to the retailer system 104. The classification data may include toxicological information, transportation information, waste information, component data, special permits, registration numbers, and so on. In some implementations, chemical composition data may be maintained by the classification system 102, but may be kept confidential.

At 410, state and municipal specific instructions for product handling may be provided to the retail system. For example, these instructions may include regulatory information, safe handling information, other information, or any combination thereof. Other implementations are also possible.

Returning to 406, if the composition is not determined, a request for data may be sent to the supplier system, at 412. For example, the request may be sent by an operator of the classification system 102 completing and submitting a form including information received from the retailer portal graphical interface, which may cause the classification system 102 to send an email to the supplier system 106 requesting an operator of the supplier system 106 to respond. In one possible implementation, opening the email using the supplier portal graphical interface may open a form with fields accessible to the operator to respond to the information request. The operator may utilize the supplier portal graphical interface to complete the form and optionally submit documentation or information related to a retail product. Such documentation may include, for example, an SDS, a product data sheet, other information, or any combination thereof. The operator may then submit the form by selecting a “submit” button or other button or by sending the email response.

At 414, data may be received from the supplier portal 106. For example, the classifier system 102 may receive the data, extract information from the received data, and index the extracted information. The data may include chemical composition data, SDS data, a product data sheet, form data, other data, or any combination thereof.

At 416, attributes of the product data may be automatically parsed and indexed from the received data. The classification system 102 may extract information from the received data and may index the extracted information so that it can be searched. In some implementations, the classification system 102 may determine a reliability or confidence value for at least some of the attributes. For example, the classification system 102 may determine a discrepancy or inconsistency within the submitted data, and may utilize one or more data sources to resolve the discrepancy. In some implementations, the classification system 102 may determine which of the data sources that resulted in the discrepancy is more reliable. For example, data retrieved based on the CAS number of a particular retail product may be treated by the classification system 102 as being more reliable than data entered by an operator of the supplier portal graphical interface. Similarly, the SDS data may be deemed more reliable than a technical data sheet. In some implementations, the classification system 102 may include a predetermined hierarchy of reliability based on various factors, and inconsistencies can be weighted based on the predetermined hierarchy. In some implementations, the classification system 102 may evaluate the reliability of the attribute data, and the reliability or confidence value can be used to weight the attribute data prior to performing calculations.

At 418, classifications for the product can be automatically calculated based on the data. For example, the classification system 102 may determine or deduce the classifications by looking up the classifications based on the data. In another example, the classification system 102 may determine composition information for the product and may automatically calculate toxicity information based on the composition information. The classification system 102 may then look up transportation and waste handling information based on the toxicity information. As mentioned above, the classifications can include transportation classifications, waste classifications, item sorting classifications, toxicity classifications, other data, or any combination thereof.

At 420, the classifications may be provided to a classification portal for review. For example, the classification portal may include a graphical interface associated with and provided by the product classification system 102 for access by an operator to review, edit, approve, or otherwise interact with the received and calculated product information and classifications. In some implementations, the classification system 102 may automatically determine the classifications and may automatically provide the classifications to the retailer system 104. The classification portal may be used to review the automatically determined classifications during a training interval, periodically, in parallel with or prior to transmission of the classifications to the retailer portal, or according to another time table. Other implementations are also possible.

At 422, if the classifications are not confirmed by the operator, a request may be sent to the supplier for further information, at 424. For example, an “expert” operator of the classification system 102 may review the automatically calculated classifications and may be unable to confirm the determination. In this example, the operator of the classification system 102 may cause the classification system 102 to send an email to the supplier system 106 requesting further information.

Alternatively, or in addition, information may be sent to one or more websites to solicit assistance through crowd sourcing. For example, the classification system 102 may provide image data, text data, and other data to a website to request further information from independent operators, such as through social media. In some examples, the information received from such independent operators can be verified prior to its use in calculating the classifications. Other implementations are also possible.

Returning to 422, if the classifications are confirmed, if the composition is determined from the database 142 of the classifier system 102, at 406, the classification data may be sent to the retailer system, at 408. At 410, state and municipal specific instructions may be sent to the retailer portal. For example, the state and municipal instructions, as well as Federal guidelines, may be part of the classification data, which may include transportation classifications, waste classifications, retail sorting classifications, other classifications, or any combination thereof.

In the above-described example, the classification system 102 may determine the transportation, waste, sorting, and other classifications from product information provided by the retailer and the supplier and from other data sources. Further, in some implementations, the classification system 102 may calculate toxicity and other information based on information received from the retailer, the supplier, and other data sources. Other implementations are also possible.

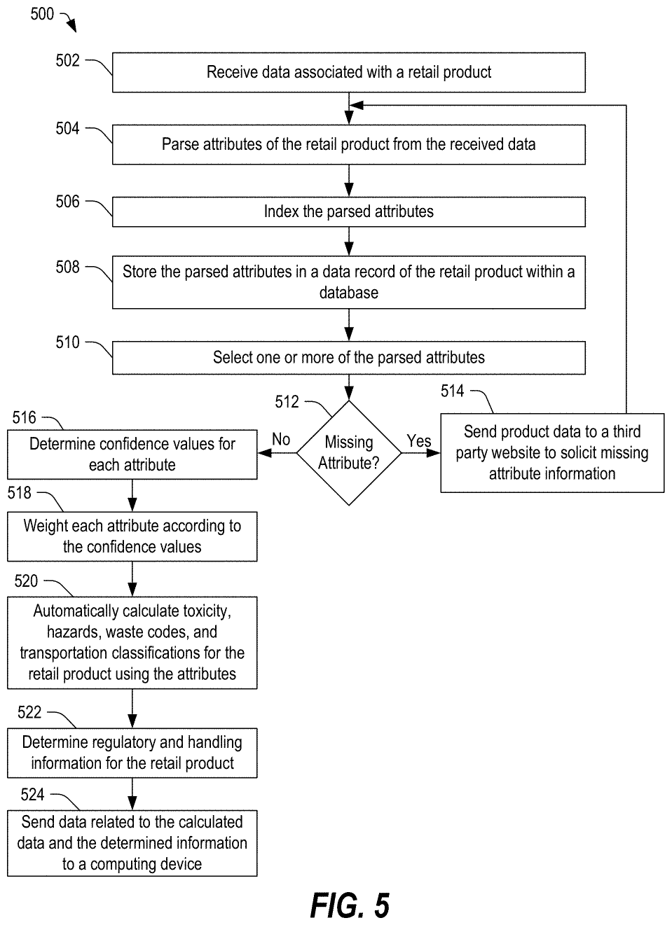

FIG. 5 depicts a flow diagram of a method 500 of classifying a product using social media, in accordance with certain embodiments of the present disclosure. At 502, data associated with a retail product may be received. For example, the data may be received from a retailer system 104 based on user-interactions with a retailer portal graphical interface, from a supplier system 106 based on user-interactions with a supplier portal graphical interface, from other sources, or any combination thereof. The data may include a UPC, product name, manufacturer name, other data, or any combination thereof. The data may also include an SDS document, a CAS number, packaging information, other data, or any combination thereof.

At 504, attributes of the retail product may be parsed from the received data. For example, attributes of the retail product may be identified and extracted from documents, forms, and other data sources. The attributes may include the CAS number, chemical composition data, safety information, other data, or any combination thereof. In some embodiments, the classification system 102 may include an attribute handler 132 that can cause the processor 112 to extract the attributes from received data and to organize the data into pre-determined categories.

At 506, the parsed attributes may be indexed. For example, indexing the parsed attributes may include processing the attributes so that they are accessible through searches. The classification system 102 may store the parsed attributes in the database in indexed fields that enable searches.

At 508, the parsed attributes can be stored in a data record of the retail product within a database. Each retail product may be represented in the database by one or more unique data records. Each data record may include details about the product as well as data corresponding to the retailer and to the supplier. Further, each data record may include one or more fields, some of which may be populated with parsed attribute data.

At 510, one or more of the parsed attributes is selected. For example, some attributes may be useful in retrieving information for determining toxicity, transportation rules, waste rules, and so on. In an example, the CAS number may be useful in determining particular information, which can be used to determine toxicity, and so on.

At 512, if an attribute is missing, at least some of the product data may be sent to a third party website to solicit missing attribute information, at 514. For example, if information corresponding to a retail product is missing, the classification system 102 may post information about the retail product to a website and request help from independent operators to acquire the missing information. In an example, a social media website may be used to host product information for which attribute data is missing and to solicit the attribute data from site members. This may enable crowd-sourcing of the information. In some implementations, any received data from the website may be provided to the classification system 102 so that attributes, such as the missing information may be parsed from the received data. Other implementations are also possible.

Returning to 512, if the attribute is not missing, confidence values for each attribute may be automatically determined, at 516. For example, the classification system 102 may determine a reliability for each attribute, and the classification system 102 may use the reliability to determine a confidence value for each attribute. In some embodiments, the confidence value may be an indication of the reliability of a source of the information. In other embodiments, the confidence value may be an indication of the consistency of a piece of information based on a comparison of the piece of information from one or more sources or from a single source. In a particular example, inconsistent data may cause the classification system 102 to decrease the reliability value. In some embodiments, each attribute may be given a reliability or confidence weight that may be normalized within a range of values including zero, one, and numbers therebetween.

At 518, each attribute can be weighted according to the determined confidence values. For example, a particular attribute may include a numeric value, such as an acidity value (pH). Depending on the confidence value, the weight of the pH in determining the toxicity and other information may be decreased, such that the acidity attribute alone is not relied upon to determine toxicity or other classifications.

At 520, the method 500 can include calculating toxicity, hazards, waste codes, and transportation classifications for the retail product using the attributes. For example, the toxicity may be calculated based on chemical composition data. In an example, the CAS number may be one of the attributes, and at least some of the toxicity, hazards, waste codes, and transportation classifications may be determined using the CAS number and other attributes. In an example, information determined using the CAS number may be used to calculate toxicity. Other implementations are also possible.

At 522, regulatory and handling information for the retail product may be determined. For example, the regulatory and handling information may be based on the calculations as well as the data retrieved based on the CAS number.

At 524, data related to the calculated information may be sent to a computing device. For example, handling information, toxicity, transportation, waste, and other classification data may be sent to the retailer system 104, and the retailer system 104 may update its product data database 226 based on the information.

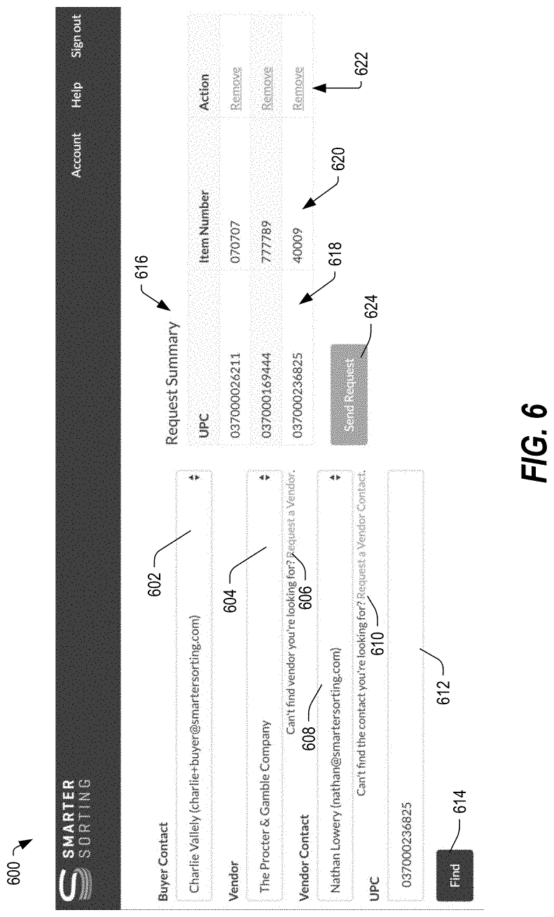

FIG. 6 depicts a graphical interface 600 provided by a retailer system 104 showing a request for product information, in accordance with certain embodiments of the present disclosure. The graphical interface 600 may include information as well as user-selectable elements, such as text fields, pull-down menus, selectable buttons, other elements, or any combination thereof.

In this example, the graphical interface 600 includes a pull-down menu 602 accessible by an operator to select a buyer contact from a list of contacts. In some embodiments, one of the selectable items within the pull-down menu 602 may include an option to add a new buyer contact, which may cause the graphical interface 600 to present a popup window or to present fields for entry of information related to the new buyer contact. Other embodiments are also possible.

The graphical interface 600 may include a Vendor pull-down menu 604 that may be accessed by an operator to select between pre-defined vendors. Additionally, the pull-down menu 604 may include an option to add new vendors, which may cause the graphical interface 600 to present a popup window or to present fields for entry of information related to the new vendor. Alternatively, or in addition, the graphical interface 600 may present a selectable link 606 to “Request a Vendor”, which may trigger an alert or an automated operation through which a new vendor may be added. Other embodiments are also possible.

The graphical interface 600 can include a pull-down menu 608 that can be accessed by an operator to select a Vendor Contact from the menu list. In some embodiments, the pull-down menu 608 may include an option to add a new vendor contact, which may cause the graphical interface 600 to present a popup window or to present fields for entry of information related to the new vendor contact. Alternatively, or in addition, the graphical interface 600 may present a selectable link 610 to “Request a Vendor Contact”, which may trigger an alert or an automated operation through which a new vendor contact may be added. Other embodiments are also possible.

The graphical interface 600 may include a universal product code (UPC) field 612. In some embodiments, the UPC value may be entered manually. In other embodiments, the UPC value may be entered by scanning a barcode. Other embodiments are also possible. The graphical interface 600 may further include a “Find” button 614 that can be accessed to find information based on the entered information. In some embodiments, the Find button 614 may be selected to search the retail product database 226.

The graphical interface 600 may also include a Request Summary 616, which may include a list of UPC values 618, item numbers 620, and operator-accessible links 622 to enable the operator to remove an item from the Request Summary 616. Further, the graphical interface 600 may include a “Send Request” button 624 accessible by an operator to initiate a request for information about the retail product from at least one of the classification system 102 and the supplier system 106. Other embodiments are also possible.

In a particular embodiment, an operator of the supplier system may add UPCs to a supplier request form within the retailer portal graphical interface 600. The operator may add one or more UPCs. The operator may then select the Buyer Contact and the Vendor involved in the interaction, allowing communication between the supplier and the vendor to be automated. Other embodiments are also possible.

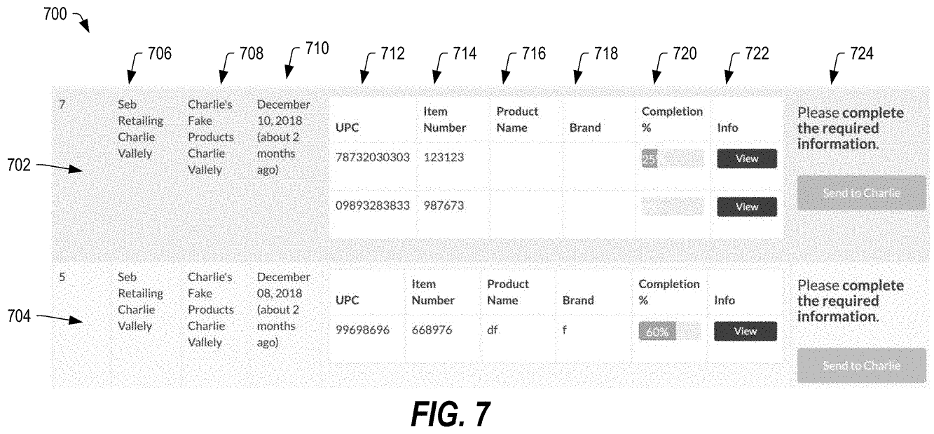

FIG. 7 depicts a graphical interface 700 provided by a supplier system 106 showing emails of requests for product information, in accordance with certain embodiments of the present disclosure. The graphical interface 700 may include a list of requests from retailer systems 104. The list may include a first request 702 and a second request 704. Each request 702 and 704 may include data related to each request.

The request may include a retailer contact 706, product information 708, a submission date 710, one or more UPCs 712, one or more item numbers 714, one or more product name fields 716, one or more brand name fields 718, and one or more response completion percentage indicators 720. Each response completion percentage indicator 720 may be related to one of the one or more UPCs 712, such that the operator of the supplier portal graphical interface 700 may complete a response to a portion of a retail product request, and the retailer system 104 and the classification system 102 can be kept apprised of the progress of the supplier's efforts to respond.

Each request 702 and 704 can further include a “View” button 722 that can be accessed by an operator to view details related to the retail product request. Further, the requests 702 and 704 may include a “Send to” button, generally indicated at 724, accessible by the operator to send the response to the requester. Other embodiments are also possible.

In some embodiments, in response to selection of the “View” button 722, the graphical interface 700 may present information related to a selected one of the requests 702 or 704. Other embodiments are also possible.

In an example, the supplier portal graphical interface 700 may present the retail product request as an email requesting the supplier to register its products. An operator of the supplier portal graphical interface may log into his or her account, or create one, to view the retail product request. Further, the supplier portal graphical interface 700 may present a graphical interface for entering product details. At the same time, the retailer portal graphical interface may be used to view the supplier's progress registering individual products. Other embodiments are also possible.

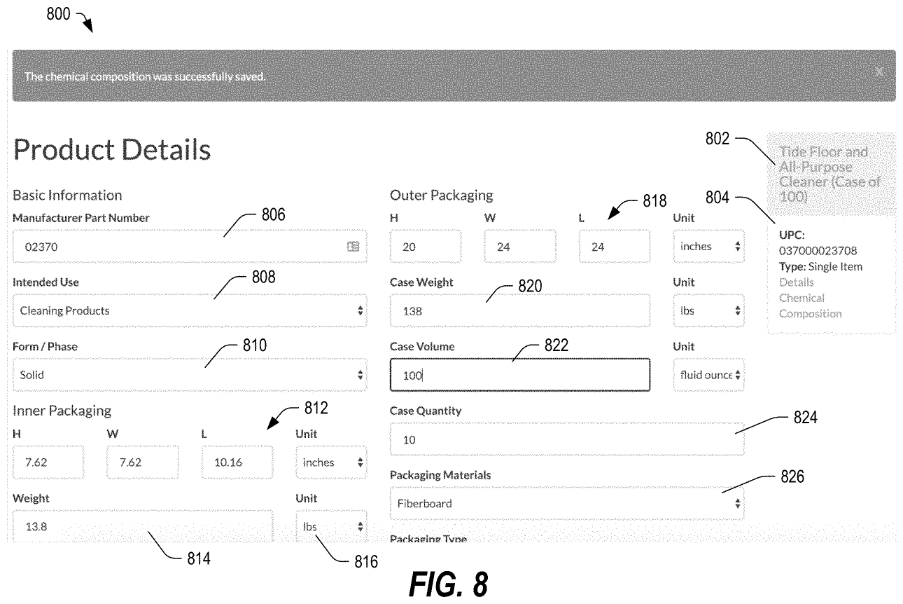

FIG. 8 depicts a graphical interface 800 provided by the supplier system 106 showing fields for entering product information, in accordance with certain embodiments of the present disclosure. The graphical interface 800 may include an identifier 802 include product name and brand information, which may be determined from the UPC. The graphical interface 800 may further include production information 804, including the UPC and other information, such as the type of item and item details, including chemical composition. Other embodiments are also possible.

The graphical interface 800 may further include a pull-down menu 806 accessible by an operator to select a manufacturer part number from a pre-determined list. The pull-down menu 806 may also include an “Add New Part Number” option accessible by the operator to create a new part number. In response to selection of the “Add New Part Number” option from the pull-down menu 806, the graphical interface 800 may present a pop-up window or text fields that can be accessed by the operator to enter information related to the new part number.

The graphical interface 800 may also include a pull-down menu 808 accessible by an operator to select an intended use from a pre-determined list. In this example, the operator has selected “Cleaning Products” from the list in the pull-down menu 808.

The graphical interface 800 may also include a pull-down menu 810 accessible by an operator to select a form/phase associated with the retail product. In this example, the operator has selected “Solid” indicating that the retail product is a solid.

The graphical interface 800 can include inner packaging details 812, such as dimensions (height, width, and length) in selected units (in this case “inches”) as well as the weight 814 in a specified unit 816 (pounds, “lbs”). The graphical interface 800 may also include outer packaging details 818, such as dimensions (height, width, and length) in selected units (inches) as well as the case weight 820 in specified units (pounds). The graphical interface 800 may further include a field 822 to receive a case volume and an associated pull-down menu to receive the units (in this case, “Fluid Ounces”). The graphical interface 800 may also include a field 824 to receive a “Case Quantity”. The graphical interface 800 may further include a pull-down menu 826 to specify the packing materials, such as Fiberboard, or other pre-defined materials. The graphical interface 800 can also include a packaging type as well as other information. Other embodiments are also possible.

In some embodiments, an operator of the supplier portal graphical interface 800 may log in to edit the information about the retail product. Once completed, the operator may submit the information, completing the request. In some instances, the product may include multiple components. Multi-component products or kits may also be supported. In the following discussion, a supplier portal graphical interface is described that may allow the operator to provide information related to the multi-component product or kit.

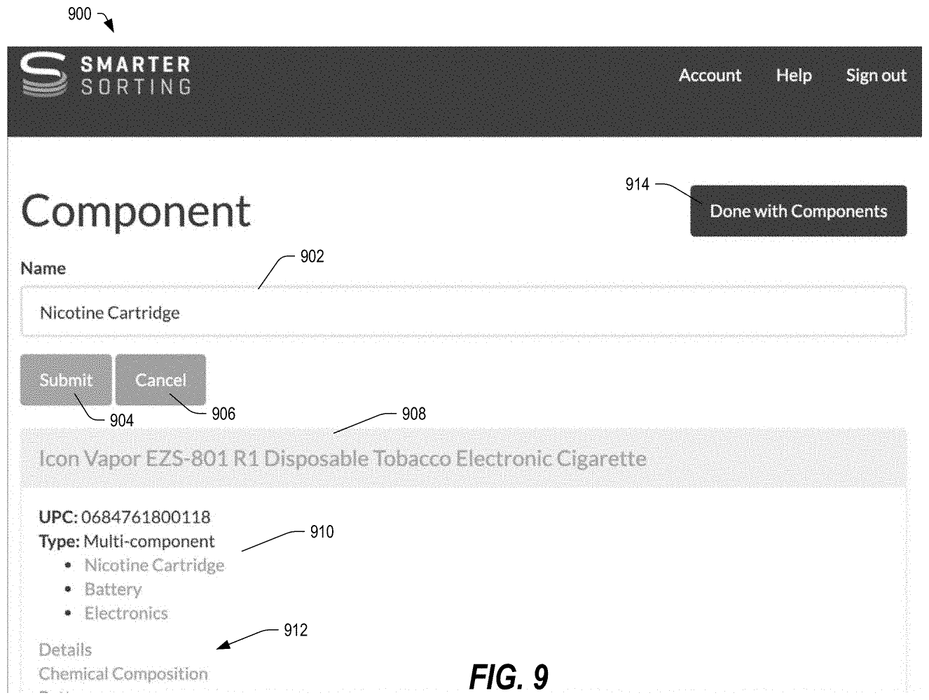

FIG. 9 depicts a graphical interface 900 provided by the supplier system 106 and supporting multi-component kits, in accordance with certain embodiments of the present disclosure. The supplier portal graphical interface 900 may include a component name field 902. In this case, the component name is “Nicotene Cartridge”. The supplier portal graphical interface 900 may further include a “Submit” button 904 and a “Cancel” button 906. The supplier portal graphical interface 900 can include a description (“Icon Vapor EZS-801 R1 Disposable Tobacco Electronic Cigarette”), further identifying information 910, and product details 912. The operator may scroll down to add additional components and to add further identifying information. Once the operator is done entering information, he or she may select a “Done with Components” button 914 to complete the data entry process.

In some embodiments, by collecting chemical and other information for each component of a multi-component product or kit, the classification calculations for transportation, waste, and so on can be determined precisely for each item of the multi-component product. In particular, the classifications can be determined with precision for even the most complex product types. Other embodiments are also possible.

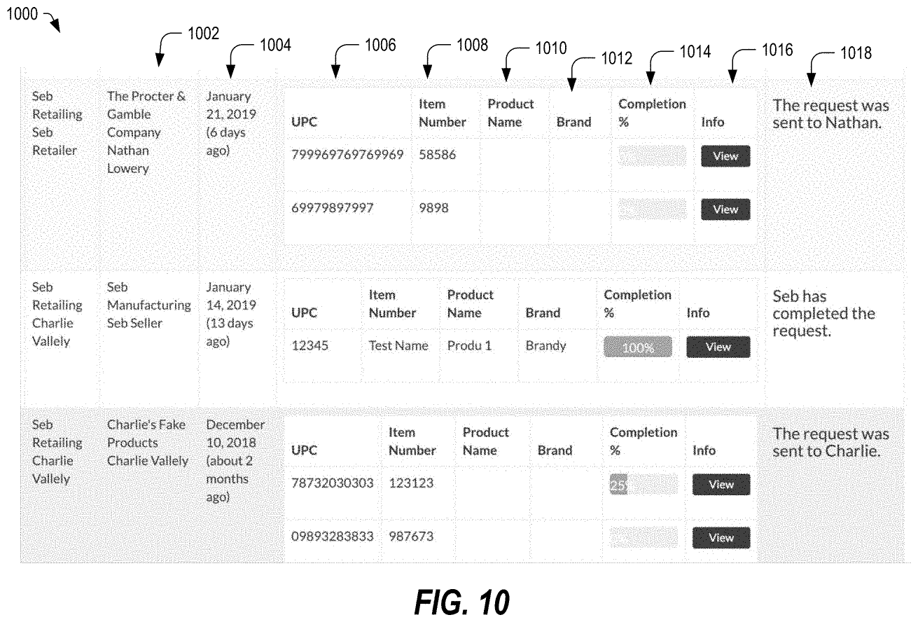

FIG. 10 depicts a graphical interface 1000 provided by the retailer system 104 showing the status of prior requests for product information, in accordance with certain embodiments of the present disclosure. The retailer portal graphical interface 1000 may include a list of retail product requests. Each product request may include a supplier name and contact 1002, a request data 1004, one or more UPCs 1006, one or more item numbers 1008, a product name 1010, a product brand 1012, and a completion percentage indicator 1014. The graphical interface 1000 may further include a “View” button 1016 accessible by an operator to view details related to the request. Further, the graphical interface 1000 may further include a status indicator 1018.

In some embodiments, an operator at the retailer system 104 can use the retailer portal graphical interface 1000 to track the progress of its suppliers in filling out data requests. In some embodiments, the classification system 102 may send automated email reminders to suppliers to complete the requests after a period of time.

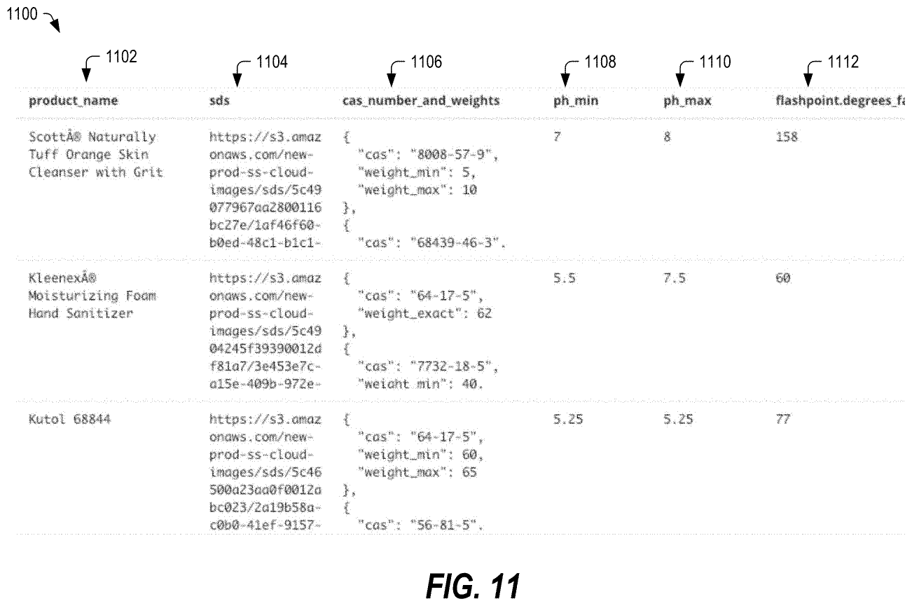

As discussed above, the classification system 102 may collect attributes associated with a retail product from the supplier. The attributes can include the UPC, product name, brand name, manufacturer name, SDS, chemical composition, component data, kit item data, manufacturer part number, intended use data, form, phase, inner and outer packaging information (including dimensions, weight, volume, material, type, other data, or any combination thereof), case quantity, battery data, special permits, registration numbers, overpack—display ready—unit load data, pictures of labels and packaging, other data, or any combination thereof. Further, the retailer may add additional fields, including item number data, supplier number data, supplier name data, department number data, department name data, category data, other data, or any combination thereof. In some embodiments, some data may be parsed from received document data, such as data extracted from the SDS. An example of data extracted from the SDS is described below with respect to FIG. 11.

FIG. 11 depicts a table 1100 of data extracted, transformed, and loaded from retailer data and supplier data received from the retailer system and the supplier system, in accordance with certain embodiments of the present disclosure. The table 1100 may include rows and columns. Each row may reflect a different retail product. The table 1100 can include a product name column 1102, an SDS column 1104 including a link to the SDS document, a CAS number and weights column 1106, a minimum acidity column 1108, a maximum acidity column 1110, and a flashpoint column 1112. The table 1100 can include further information (not shown) that is extracted from the SDS, determined from other sources, or any combination thereof.

In some embodiments, the classification system 102 may parse attributes from each SDS and index them. If the classification system 102 fails to extract a selected attribute, the attributes may be parsed manually through crowd-sourcing, which may represent a low-cost, semi-automated system to serve repeatable data tasks to people (independent contractors). Parsed attributes can include CAS numbers, flashpoint temperature, acidity numbers, density, and many more. Further, the classification system 102 can capture product labels, which may also be parsed. In an example, the classification system 102 may share sufficient information for an independent operator to determine the missing attributes, but without sharing composition percentages and other proprietary information.

Attributes can beget more attributes and richer data. Knowing the CAS numbers makes it possible for the classification system 102 to retrieve chemical, toxicological, and regulatory data from a variety of data sources. Further, the data expansion makes it possible to improve calculations for toxicity, hazards, waste codes, and transportation classifications.

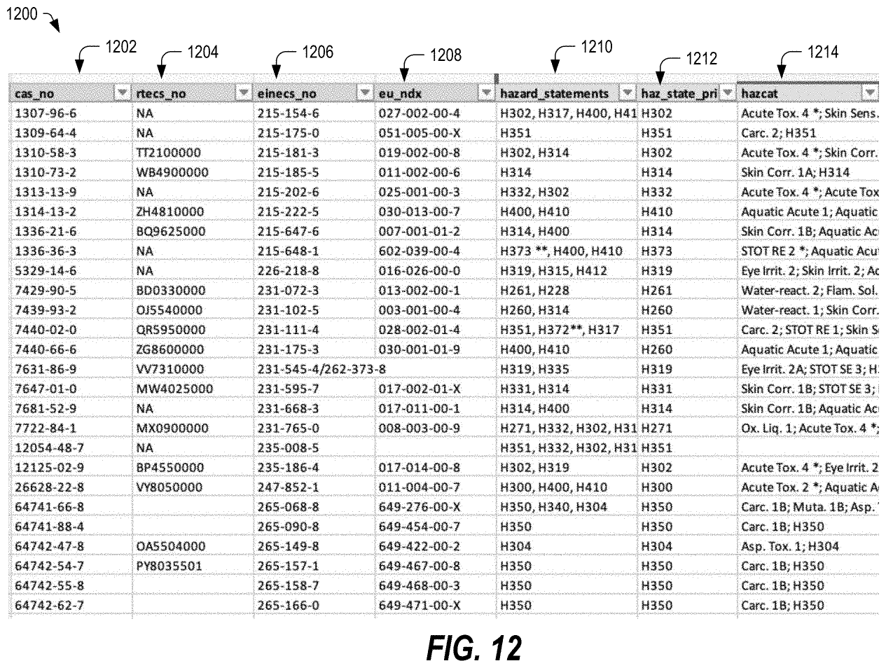

FIG. 12 depicts a table 1200 of chemical abstract service (CAS) numbers and attributes stored by the product classification system and used to determine toxicity, hazards, waste codes, and transportation classifications, in accordance with certain embodiments of the present disclosure. The table 1200 may include a column of CAS number 1202, a column of Rural Transit Enterprises Coordinated (RTEC) numbers 1204, a column of European Inventory of Existing Commercial Chemical Substances (EINECS) numbers 1206, European Union index numbers 1208, hazard statements 1210, primary hazard statements 1212, Hazcat® codes 1214, other data, or any combination thereof.

In the illustrated embodiment, data collected from various data sources may improve calculations for toxicity, hazards, waste codes, and transportation classifications. Different attributes collected from suppliers or manufacturers may conflict. In an example, an SDS may list a product as “not regulated” in Section 14, but the same SDS may list a flashpoint of the product as 80 F and thus the product is flammable. The classification system 102 may determine for each source of data a confidence value which represents a weighted confidence assigned to each source. Programmatic tests can be run to determine proper canonical values for each attribute. Based on these attributes, rule sets can be applied to determine transportation and waste classifications as well as sorting instructions for a sorting device, which may be hosted at a retail location. Other implementations are also possible.

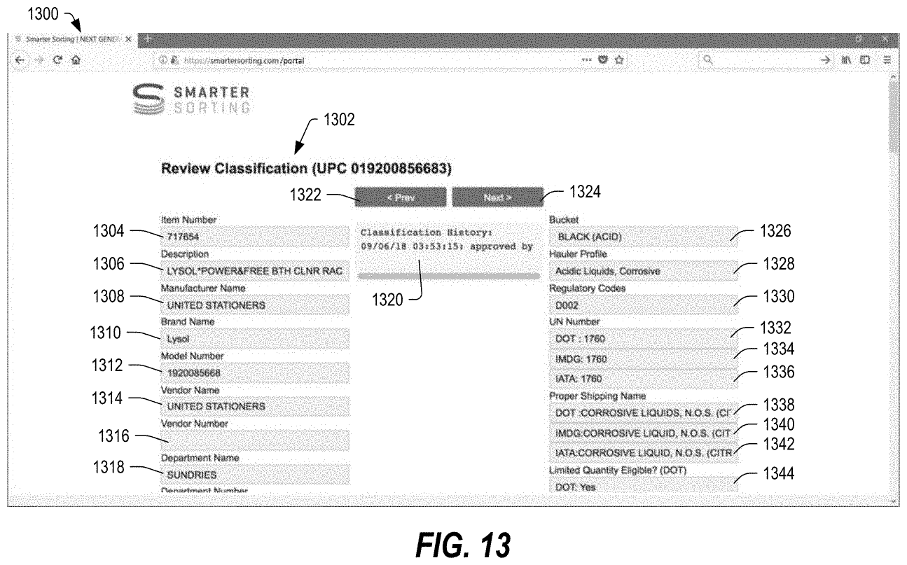

In some embodiments, once classifications are determined for a particular retail product, the classifications may be provided to the retailer portal graphical interface of the retailer system 104, allowing an operator of the retailer system to view the classifications and optionally to edit the classifications, to request further review, and so on. The classifications can include toxicity classifications, transportation classifications, waste code classifications, sorting classifications, and so on. One possible example of a retailer portal graphical interface that allows for review of the determined classifications is described below in FIG. 13.

FIG. 13 depicts a graphical interface 1300 provided by the product classification system and including classification data for a particular product for review, in accordance with certain embodiments of the present disclosure. The graphical interface 1300 may include data determined by the above-described processes. The graphical interface 1300 may include a UPC 1302 of a currently selected retail product record of a plurality of retail product records. The graphical interface 1300 may include a “Previous” button 1322 accessible by an operator to access a previous retail product record and a “Next” button 1324 accessible by an operator to access a next retail product record.

The graphical interface 1300 may include an item number 1304, a description of the retail product 1306, a manufacturer name 1308, a brand name 1310, a model number 1312, a vendor name 1314, and a vendor number 1316. The graphical interface 1300 may further include a department name 1318 and classification history information 1320. The graphical interface 1300 may also include a sorting bucket or bin 1326, which may be associated with the sorting device at the retailer location for sorting unsaleable items into a suitable bin or palette for temporary storage and subsequent disposal or repurposing.

The graphical interface 1300 can further include a hauler profile 1328 and regulatory codes 1330. The graphical interface 1300 may also include United Nations (UN) numbers including a UN transportation number 1332, an International Maritime Dangerous Goods (IMDG) code 1334, and International Air Transportation Association (IATA) code 1336. Further, the graphical interface 1300 may include proper shipping names including a Department of Transportation (DOT) proper shipping name 1338, a IMDG proper shipping name 1340, and an IATA proper shipping name 1342. The graphical interface 1300 can also include a “limited quantity” eligibility indicator 1344 for each of the DOT, IMDG, and IATA, for example. It should be appreciated that the “limited quantity” may refer to a maximum quantity per inner packaging or article for transporting dangerous goods in limited quantities, which quantities are granted relief from certain hazmat shipping requirements. In some embodiments, the operator may scroll down to view additional information including further classification data. Other embodiments are also possible.

In the illustrated example of FIG. 13, the retailer portal graphical interface 1300 may depict the classifications for ground transportation, air transportation, maritime transportation, Federal waste codes, State waste codes, sorting bucket or bin classifications, other classifications, or any combination thereof. An operator of a retailer portal graphical interface 1300 may review the data and optionally select a record for further review. In one possible example, right-clicking on a field within the graphical interface 1300 may cause the graphical interface 1300 to display a pop-up menu that may allow the operator to “flag” the record or a field to trigger an expert review of the classifications. Other embodiments are also possible.

In conjunction with the systems, devices, graphical interfaces, and methods described above with respect to FIGS. 1-13, a computing system may be configured to receive data corresponding to a retail product, such as a chemical product. The computing system may parse the received data to extract a plurality of attributes, search one or more data sources to retrieve information related to the attributes, assign confidence weights to each of the attributes, and calculate one or more classifications for the retail product, including transportation classifications, waste classifications, and sorting classifications, using the confidence weighted attributes. In some embodiments, the classifications may be presented within a retailer portal graphical interface for review by an operator associated with a retailer system. In other embodiments, the classifications may be presented to an operator of a classification system within a graphical interface to allow an “expert” to review the classifications. In some embodiments, the operator associated with the retailer system may interact with the retailer portal graphical interface to trigger the expert review. Other embodiments are also possible.

Although the present invention has been described with reference to preferred embodiments, workers skilled in the art will recognize that changes may be made in form and detail without departing from the scope of the invention.

What is claimed is:

1. A system comprising:
an interface communicatively coupled to a network;
a processor; and
a memory to store instructions that cause the processor to:
receive data about a retail product from one of a retailer system and a supplier system through the network;
automatically parse and index attributes from the received data, the indexed attributes including a chemical abstracts services number;
determine one or more classifications based on the indexed attributes; and
provide retail product data including the one or more classifications to the retailer system via the network.

2. The system of claim 1, further comprising instructions that cause the processor to:
retrieve chemical, toxicological, and regulatory data from one or more data sources; and
apply the chemical, toxicological, and regulatory data to determine the one or more classifications.

3. The system of claim 1, wherein the one or more classifications includes toxicity classifications, hazards classifications, waste code classifications, and transportation classifications.

4. The system of claim 1, wherein the one or more classifications includes sorting device classifications provided to an item sorting device at a retail facility, the sorting device classifications including a disposal bin classification, a donation eligibility classification, a recycle path classification, a reuse in warehouse eligibility classification, and a multi-component handling instructions classification.

5. The system of claim 1, further comprising instructions that cause the processor to:
assign a weighted confidence value to each source of data; and
weight each of the attributes based on the weighted confidence value.

6. The system of claim 1, further comprising instructions that cause the processor to:
provide a retailer portal graphical interface to the retailer system through the network; and
receive the data about the retail product from the retailer system via the retailer portal graphical interface.

7. The system of claim 1, further comprising instructions that cause the processor to:
provide a supplier portal graphical interface to the supplier system through the network to request information about the retail product, the supplier portal graphical interface including an information request; and
track progress of a response to the information request; and
provide a retailer portal graphical interface including a progress indicator corresponding to the tracked progress to the retailer system.

8. A method comprising:
receiving data about a retail product from one of a retailer system and a supplier system through the network;
automatically parsing attributes from the received data, the parsed attributes including a chemical abstracts services number;
automatically indexing the parsed attributes;
determining one or more classifications based on the indexed attributes; and
providing retail product data including the one or more classifications to the retailer system via the network.

9. The method of claim 8, further comprising:
automatically retrieving chemical, toxicological, and regulatory data from one or more data sources; and
automatically applying the chemical, toxicological, and regulatory data to determine the one or more classifications.

10. The method of claim 8, wherein determining one or more classifications based on the indexed attributes, further comprising:
automatically determining toxicity classifications based on the indexed attributes;
automatically determining hazards classifications based on the indexed attributes;
automatically determining waste code classifications based on the indexed attributes; and
automatically determining transportation classifications based on the indexed attributes.

11. The method of claim 8, wherein determining the one or more classifications, further comprising
automatically determining sorting device classifications for sorting unsaleable retail products using an item sorting device at a retail facility, the sorting device classifications including a disposal bin classification, a donation eligibility classification, a recycle path classification, a reuse in warehouse eligibility classification, and a multi-component handling instructions classification.

12. The method of claim 8, further comprising:
automatically determining a confidence value for each source of data;
automatically assigning the confidence value to each attribute of each source of data to determine weighted attributes; and
automatically determining, for each of the attributes, a weighted attribute based on the confidence value.

13. The method of claim 8, further comprising:
providing a retailer portal graphical interface to the retailer system through the network; and
receiving the data about the retail product from the retailer system via the retailer portal graphical interface.

14. The method of claim 8, further comprising:
providing a supplier portal graphical interface to the supplier system through the network, the supplier portal graphical interface including a message including information and requesting information about the retail product, the supplier portal graphical interface including an information request;
tracking progress of a response to the information request; and
providing a retailer portal graphical interface including a progress indicator corresponding to the tracked progress to the retailer system.

15. A system comprising:
an interface communicatively coupled to a network;
a processor; and
a memory to store instructions that cause the processor to:
automatically index attributes from data about a retail product received from one of a retailer system and a supplier system through the network;
automatically determine a plurality of classifications based on the indexed attributes, the plurality of classifications include one or more toxicity classifications, one or more hazards classifications, one or more waste code classifications, and one or more transportation classifications; and
provide retail product data including the plurality of classifications to the retailer system via the network.

16. The system of claim 15, further comprising the memory including instructions that cause the processor to:
retrieve chemical, toxicological, and regulatory data from one or more data sources based on the indexed attributes; and
apply the chemical, toxicological, and regulatory data to determine the plurality of classifications.

17. The system of claim 15, wherein the plurality of classifications includes toxicity classifications, hazards classifications, waste code classifications, transportation classifications, and sorting device classifications.

18. The system of claim 15, further comprising instructions that cause the processor to:
assign a weighted confidence value to each source of data; and
weight each of the attributes based on the weighted confidence value.

19. The system of claim 15, further comprising instructions that cause the processor to:
provide a retailer portal graphical interface to the retailer system through the network; and
receive the data about the retail product from the retailer system via the retailer portal graphical interface.

20. The system of claim 15, further comprising instructions that cause the processor to:
provide a supplier portal graphical interface to the supplier system through the network to request information about the retail product, the supplier portal graphical interface including an information request; and
track progress of a response to the information request; and
provide a retailer portal graphical interface including a progress indicator corresponding to the tracked progress to the retailer system.
